(19) United States
(12) Patent Application Publication
(10) Pub. No.: US 2015/0000994 A1
(43) Pub. Date: Jan. 1, 2015

(54) ACTIVE HOOD OR BONNET SYSTEM FOR A VEHICLE

(71) Applicant: Jaguar Land Rover Limited, Whitley Coventry Warwickshire (GB)

(72) Inventor: William McLundie, Bromsgrove (GB)

(73) Assignee: Jaguar Land Rover Limited, Whitley Conventry Warwickshire (GB)

(21) Appl. No.: 14/376,941

(22) PCT Filed: Feb. 5, 2013
(86) PCT No.: PCT/EP2013/052251

§ 371 Date: Aug. 6, 2014

(30) Foreign Application Priority Data
Feb. 6, 2012 (GB) 1201965.9
Feb. 6, 2012 (GB) 1201966.7

(51) Int. Cl. B60R 21/38

(52) U.S. Cl. CPC B60R 21/38
USPC 180/274; 296/187.09; 296/187.04

(57) ABSTRACT

A vehicle (10) comprising a bonnet or hood assembly (12) having a passive pedestrian impact zone (P) and a second active pedestrian impact zone (A); the active zone being deployable by an actuator (30) upon receipt of a deploy signal from a control unit the second active zone being coupled to the bonnet assembly by one or more tethers (54, 56). The control unit receives data input from sensors (22) or other measurement devices and determines if the predetermined conditions for deployment of the second active zone are met.

### TECHNICAL FIELD

The present invention relates to an active hood or bonnet system for a vehicle and particularly, but not exclusively, to a dual zone hood or bonnet system that is intended to manage the energy of an impact between a pedestrian and the bonnet or hood region of a vehicle during a pedestrian/vehicle collision using both passive and active safety measures. Aspects of the invention relate to a vehicle bonnet assembly, a vehicle, a control unit and to a method.

### BACKGROUND

It is known that serious injury or death may result in the event of an impact between a pedestrian and a moving vehicle. To mitigate the severity of such an impact, vehicle manufacturers have provided energy absorbing features in the front structure of many passenger cars. Such structures include front bumpers, radiator grilles, bonnets (or hoods) and front fenders. In the event of an impact with a pedestrian, these structures are arranged to deform in a controlled manner in order to yield under the loading by the pedestrian, thus managing peak loading and the risk of direct contact with rigid structures such as the engine or battery.

It is also know to provide active countermeasures to manage the energy of an impact with a pedestrian; such active devices include active or ‘pop-up’ bonnets, which are lifted by an actuator.

The kinematics of a pedestrian during a collision with a moving vehicle can be complex but can be considered in four stages. In the first stage, the leading edge of the vehicle, usually the bumper, initially contacts the leg of a pedestrian. In a second stage, a leading edge of the bonnet or hood contacts the upper leg of the pedestrian. In the third stage, the pedestrian tends to fall over towards the vehicle, wrapping around or rolling over onto an upper surface of the bonnet or hood. The pedestrian's upper body and/or head may contact the bonnet directly. Depending upon the size and stature of the pedestrian, the speed of the collision, and the vehicle size and shape, the pedestrian may make contact with the windscreen or surrounding structure. In the fourth stage, the pedestrian lands on the bonnet, deforming it as the bonnet supports their mass during the event. This deformation serves to absorb at least some of the energy from the impact.

The bonnet is arranged to cover components such as the engine, battery and vehicle suspension components. By necessity, these components are substantially rigid and so it is desirable to prevent direct contact between a pedestrian and such components in the event of an impact. Deformation of the bonnet towards these components is managed, so as to provide maximum deformation space for the bonnet, thus absorbing as much of the energy from the impact as possible.

In order to increase the available space for bonnet deformation, it is known to provide a vehicle with an active bonnet, such systems comprise one or more sensors for detecting contact with a pedestrian. Active bonnets are intended to deploy to an elevated position in the event of an impact with a pedestrian, increasing the available space into which the bonnet may deform and thus increase the amount of energy that may be absorbed by the bonnet from such an event. Typically, active bonnet systems are arranged to raise an entire, unitary upper surface of the bonnet away from the engine and other structures in the engine bay during deployment.

The time elapsed between the initial impact with a pedestrian, and their upper body or head contacting the bonnet depends upon a number of factors, including the vehicle shape or profile. The leading edge of the bonnet typically presents a pivot or bending point about which a pedestrian tends to wrap around in the event of a collision. The time between the pedestrian first contacting the leading edge of the bonnet and their upper body contacting the top of the bonnet is dependent in part on the height of the pedestrian, generally a shorter height results in a shorter interval.

It is desirable that the active bonnet is deployed to an elevated position and in a static condition before it is called upon to support the mass of a pedestrian during an impact.

In some circumstances, it may be difficult to fully deploy the entire bonnet to a static condition before the pedestrian makes contact with it, due to the inertia of the active bonnet and the time needed to raise it to a fully deployed position.

It is against this background that the present invention has been conceived. Embodiments of the invention may provide a bonnet assembly, a system, a vehicle or a method that overcomes or at least mitigates the problems of the prior art. Other aims and advantages of the invention will become apparent from the following description, claims and drawings.

### SUMMARY

Aspects of the invention relate to a vehicle bonnet assembly, a vehicle, a control unit and to a method as claimed in the appended claims.

According to another aspect of the invention for which protection is sought, there is provided a vehicle bonnet assembly for managing the energy from an impact with a pedestrian, the assembly comprising at least one passive pedestrian impact protection section and at least one active pedestrian impact protection section wherein both passive and active pedestrian impact protection section are provided on an upper surface of the bonnet assembly, the active pedestrian impact protection section being detachably fixed to a vehicle bonnet, and wherein in the event of an impact the active pedestrian impact protection section is arranged to: detach from the vehicle bonnet; and separate from, and be moveable relative to, the passive pedestrian impact protection section.

The active pedestrian impact protection section may be moveable from a non-deployed position to a deployed position, at least a portion of the active pedestrian impact protection section, when the bonnet assembly is in use on a vehicle, provides an increased space for movement or deformation, between the active pedestrian impact protection section and items, such as, but not limited to; vehicle components including for example; engine, engine mounts, suspension turrets; spare wheel; luggage; or other cargo, disposed beneath the active pedestrian impact protection section when said portion is disposed in the deployed position than when said portion is disposed in the non-deployed position.

Advantageously, the active pedestrian impact protection section of the bonnet is arranged to be sufficiently rigid to support the pedestrian during an impact and spread the load over as wide an area of the vehicle as possible. In this way, the active pedestrian impact protection section of the bonnet manages the energy of the impact with the pedestrian by a combination of deflection towards the vehicle, and controlled localised deformation.

In one embodiment the bonnet assembly is arranged such that, on deployment of the active pedestrian impact protection section, movement of the active pedestrian impact protection section is constrained. The bonnet assembly may be arranged such that the when the active pedestrian impact protection section is deployed, the bonnet assembly does not obscure the driver's view.

Advantageously, the restraining of the active pedestrian impact protection section controls its movement during deployment and manages the final location and attitude of the active pedestrian impact protection section once fully deployed. Ultimately, this control over the deployment kinematics of the active pedestrian impact protection section maintains repeatability and enhances stability under loading by the pedestrian.

Optionally, the at least one active pedestrian impact protection section is located rearwards of the passive pedestrian impact protection section.

Optionally, the at least one active pedestrian impact protection section comprises an actuator for elevating a moveable portion of the active section of the bonnet assembly. Optionally, the actuator is an airbag. Alternatively, the actuator is pyrotechnically activated or pneumatically activated.

In one embodiment the bonnet assembly comprises an actuator for elevating at least a moveable portion of the bonnet assembly within the at least one active section of the bonnet assembly.

Optionally, the actuator is an airbag. The actuator may be activated pyrotechnically or pneumatically.

Optionally, the assembly comprises one or more tethers to limit or restrict movement of the moveable portion. When an airbag is provided the tethers may be arranged so that the assembly constrains inflation of the airbag across at least a portion thereof. Optionally, only the central portion of the airbag is constrained or otherwise controlled.

This has the advantage of maintaining the driver's field of view across at least a portion of the windscreen during the deployment of the active section of the bonnet.

It is further envisaged that when in the deployed position, the tethers solely couple the moveable portion to the vehicle, the tethers and the moveable portion may control inflation of the airbag. In this way, the tethers control, and ultimately constrain the maximum displacement of the moveable portion relative to the vehicle during loading.

In some embodiments the airbag, when fully inflated, extends beyond the lateral extent of the moveable portion. Optionally, the airbag covers the entire width of the bonnet or hood.

The moveable portion may be disposed over or above the actuator or airbag and substantially cover at least a central portion of the actuator or airbag when in the deployed position.

In some embodiments the airbag comprises one or more lateral outer portions, which one or more lateral outer portions of the airbag have a greater maximum elevation than a central region of the airbag and/or than moveable portion in the deployed position.

Optionally, the bonnet assembly further comprises a control unit which is operable to receive data input from the one or more sensors and/or other measurement devices disposed on the vehicle and is operable to determine, based on predefined criteria whether to deploy the active section.

Optionally, the passive pedestrian impact protection section comprises a passive, static or non-deploying, energy absorbing region, the active pedestrian impact protection section comprises a moveable portion moveable between a first, stowed position and a second, deployed position, wherein deployment of the moveable portion increases the distance between the moveable portion and vehicle components disposed beneath the active section.

Optionally, the moveable portion extends across the entire bonnet or hood of the vehicle.

Optionally, the active section is disposed towards the rear of the bonnet assembly.

Optionally, the tethers couple the moveable portion to the vehicle in the deployed position, the tethers and the moveable portion control inflation of the airbag.

Optionally, the moveable portion of the bonnet floats or is suspended upon the airbag.

Optionally, the moveable portion is disposed over the actuator or airbag and substantially covers at least a central portion of the actuator or airbag when in the deployed position.

In embodiments of the invention, the active section is effective from a wraparound distance substantially equal to 1700 mm.

Preferably, the moveable portion forms a moveable contact and support zone for support of a pedestrian in the event of an impact, said support zone being deformable and/or moveable for absorbing collision energy, the moveable portion being deformable and/or moveable into a space created by deployment of the moveable portion.

A further aspect of the invention, for which protection is sought, provides a vehicle comprising the vehicle bonnet assembly described hereinabove.

Yet another aspect of the invention, for which protection is sought, provides a method of deploying an active region of a vehicle bonnet assembly, the method comprising sensing impact with an object, determining that said object may be a pedestrian, activating an actuator to deploy a section of a vehicle bonnet or hood to an elevated position.

According to another aspect of the invention for which protection is sought, there is provided a vehicle bonnet assembly for managing the energy from an impact with a pedestrian, the assembly comprising at least one passive pedestrian impact protection section and at least one active pedestrian impact protection section wherein both passive and active pedestrian impact protection section are provided on an upper surface of the bonnet assembly and the active pedestrian impact protection section is arranged to be moveable relative to the passive pedestrian impact protection section

The active section may be moveable from a non-deployed position to a deployed position, wherein, in the deployed position, at least a portion of the active section is arranged, when the bonnet assembly is in use on a vehicle, to provide an increased space for displacement or deformation between active section and items, such as, but not limited to; vehicle components including for example; engine, engine mounts, suspension turrets; spare wheel; luggage; or other cargo, disposed beneath the active section than when said portion is in the non-deployed position.

Advantageously, the active section of the bonnet may be arranged to be sufficiently rigid to support the pedestrian during an impact and spread the load over as wide an area of the vehicle as possible. In this way, the active section of the bonnet manages the energy of the impact with the pedestrian by a combination of deflection towards the vehicle, and controlled localised deformation.

In one embodiment the bonnet assembly is arranged such that, on deployment of the active section, movement of the active section is constrained. The bonnet assembly may be arranged such that, when the active region is deployed, the bonnet assembly does not obscure the driver's view.

Advantageously, the restraining of the active section may control its movement during deployment and manages the final location and attitude of the active section once fully deployed. Ultimately, this control over the deployment kinematics of the active section maintains repeatability and enhances stability under loading by the pedestrian.

Optionally, the at least one active section is located rearwards of the passive section.

In one embodiment the at least one active section comprises an actuator for elevating a moveable portion of the active section and optionally, the moveable portion is pivotally coupled to a static section forming part of the at least one passive section.

Optionally, the actuator is an airbag or spring loaded mechanism.

Alternatively, the actuator is pyrotechnically activated or is pneumatically activated.

Optionally, the bonnet assembly is coupled to a control unit for receiving data input from one or more sensors and/or other measurement devices disposed on the vehicle and the control unit being operable to determine, based on predefined criteria, whether to deploy the active section.

Optionally, the bonnet or hood comprises a hinge pivotally coupling the or each at least one passive section to the or each at least one active section. In one embodiment the hinge is a live hinge.

In one embodiment the hinge defines, at least in part, a transition between a passive pedestrian impact section and an active pedestrian impact section.

Optionally, the passive section comprises passive protection measures comprises a passive static or non-deploying energy absorbing region, and the active section comprises a moveable portion moveable between a first, stowed, position and a second, deployed position, wherein deployment of the moveable portion increases the distance between the moveable portion and vehicle components disposed beneath the active section.

In some embodiments the moveable portion extends across the entire bonnet or hood.

Optionally, the active section is disposed towards the rear of the bonnet or hood.

Optionally, the moveable portion is deployed to a stationary position prior to pedestrian impact with the active section. The active section may be provided with an airbag. Optionally, the airbag is the actuator.

Advantageously, the leading edge of the bonnet may remain static during deployment of the active section. In this way, the leading edge of the bonnet and the passive pedestrian impact protection section may be optimised for energy management independently from active section.

It is envisaged that the bonnet assembly may comprise one or more tethers to limit or restrict movement of the moveable portion. Optionally, the tethers control or otherwise constrict inflation of the airbag across at least a portion thereof.

This has the advantage of maintaining the driver's field of view across at least a portion of the windshield during the deployment of the active section of the bonnet.

It is further envisaged that when in the deployed position, the tethers solely couple the moveable portion to the vehicle, the tethers and the moveable portion may control inflation of the airbag. In this way, the tethers control, and ultimately constrain the maximum displacement of the moveable portion relative to the vehicle during loading.

Optionally, the moveable portion of the bonnet assembly floats or is suspended upon the airbag.

In embodiments where an airbag is provided, inflation of the airbag may be constricted across a central portion thereof, preferably only the central portion of the airbag is constricted.

Optionally, the airbag, when fully inflated, extends beyond the lateral extent of the moveable portion. The airbag may cover the entire width of the bonnet or hood in embodiments of the invention.

Optionally, the moveable portion is disposed over the actuator or airbag and substantially covers at least a central portion of the actuator or airbag when in the deployed position.

Optionally, one or more outer portions of the airbag have a greater maximum elevation than a central region of the airbag and/or than the deployable region in the deployed position.

In some embodiments the active section is effective from a wraparound distance substantially equal to 1700 mm.

Optionally, the moveable portion is hinged to the vehicle and is pivotally moveable to a deployed position.

It is envisaged that the moveable portion may form a contact and support region which is deformable and/or moveable for absorbing collision energy, the moveable portion being deformable and/or moveable into a space created by deployment of the moveable portion.

According to a further aspect of the invention for which protection is sought, there is provided a vehicle comprising a vehicle bonnet assembly described hereinabove.

According to a still further aspect of the invention for which protection is sought, there is provided a method of deploying an active region of a vehicle bonnet or hood comprising sensing impact with an object, determining that said object may be a pedestrian, activating an actuator to deploy an active region of a vehicle bonnet or hood to an elevated position.

Within the scope of this application it is envisaged that the various aspects, embodiments, examples, features and alternatives set out in the preceding paragraphs, in the claims and/or in the following description and drawings may be taken independently or in any combination thereof. For example, features described in connection with one embodiment are applicable to all embodiments unless there is incompatibility of features.

### BRIEF DESCRIPTION OF DRAWINGS

Embodiments of the invention will now be described, by way of example only, with reference to the accompanying drawings, in which:

FIG. 1 is a side view of a vehicle comprising an active bonnet system according to a first embodiment of the invention;

FIG. 2 is a top view of a vehicle according to FIG. 1;

FIG. 3 is a side view of the vehicle of FIG. 1 in which the active bonnet system has been activated or deployed; the actuator has been removed for ease of understanding;

FIG. 4 is a side view of the vehicle of FIG. 1 illustrating collision with a small statured pedestrian; the actuator has been removed for ease of understanding;

FIG. 5 is a side view of the vehicle of FIG. 1 illustrating collision with a tall statured pedestrian; the actuator has been removed for ease of understanding;

FIG. 6A is a cross sectional view of the trailing edge of the bonnet or hood of the vehicle illustrated in FIG. 1 in an un-deployed state;

FIG. 6B corresponds to FIG. 6A in which the system is in a deployed state;

FIG. 7A illustrates a perspective view from above of a leading portion of a vehicle comprising the active bonnet system in which the system is in an un-deployed or stowed condition;

FIG. 7B corresponds to FIG. 7A and shows the system in a deployed condition;

FIG. 8 is a top view of a vehicle according to an alternative embodiment;

FIG. 9 is a side view of a vehicle comprising an active bonnet system according to an embodiment of the invention;

FIG. 10 is a top view of a vehicle according to FIG. 9;

FIG. 11 is a side view of the vehicle of FIG. 9 in which the active bonnet system has been activated or deployed;

FIG. 12 is a side view of the vehicle of FIG. 9 illustrating collision with a small statured pedestrian;

FIG. 13 is a side view of the vehicle of FIG. 9 illustrating collision with a large statured pedestrian;

FIG. 14 is an enlarged side view of the vehicle of FIG. 9;

FIG. 15 is a cross sectional view through the bonnet or hood of the vehicle illustrated in FIG. 9;

FIG. 16 is a top view of a vehicle according to a further embodiment on the invention;

FIG. 17A illustrates a cross sectional view of the trailing edge of a bonnet according to an embodiment of the invention in an un-deployed state;

FIG. 17B corresponds to FIG. 17A in which the system is in a deployed state;

FIG. 18A illustrates a perspective view from above of a leading portion of a vehicle comprising a safety system according to an alternative embodiment of the invention in which the system is in an un-deployed or stowed condition; and

FIG. 18B corresponds to FIG. 108 and shows the system in a deployed condition.

### DETAILED DESCRIPTION

Detailed descriptions of specific embodiments of the active bonnet system are disclosed herein. It will be understood that the disclosed embodiments are merely examples of the way in which certain aspects of the invention can be implemented and do not represent an exhaustive list of all the ways the invention may be embodied. Indeed, it will be understood that the active bonnet system described herein may be embodied in various and alternative forms. The Figures are not necessarily to scale and some features may be exaggerated or minimised to show details of particular components. Well-known components, materials or methods are not necessarily described in great detail in order to avoid obscuring the present disclosure. Any specific structural and functional details disclosed herein are not to be interpreted as limiting, but merely as a basis for the claims and as a representative basis for teaching one skilled in the art to variously employ the invention.

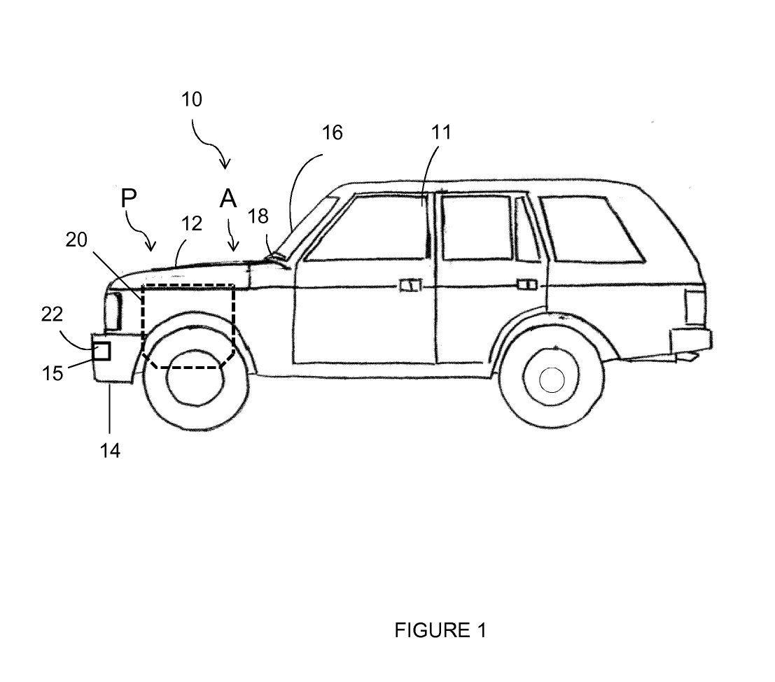

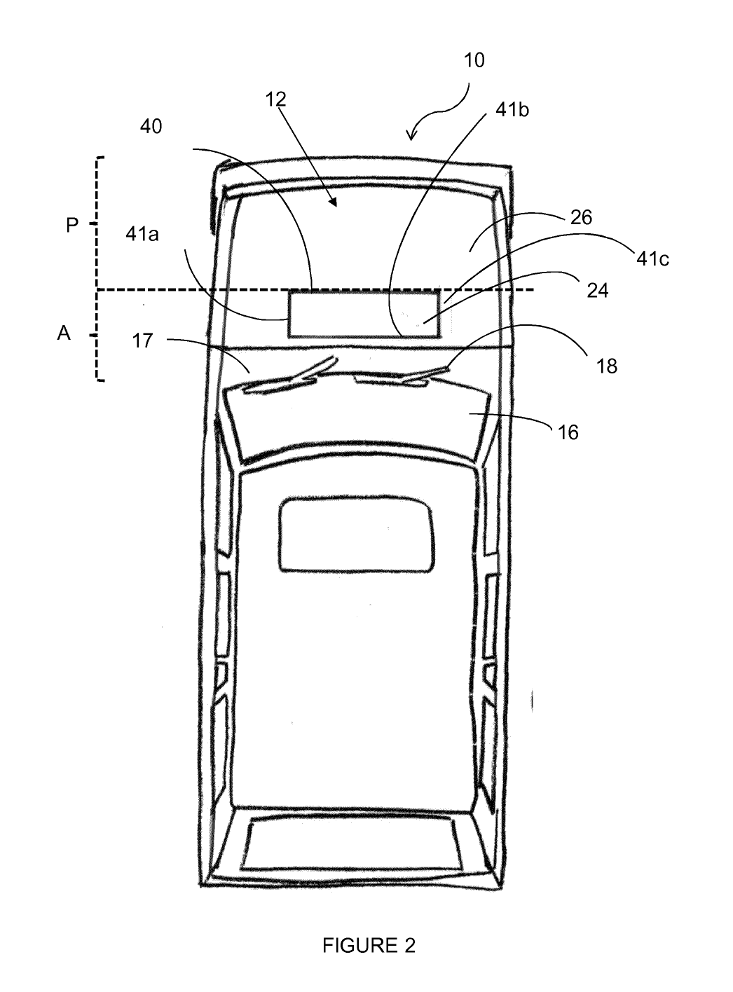

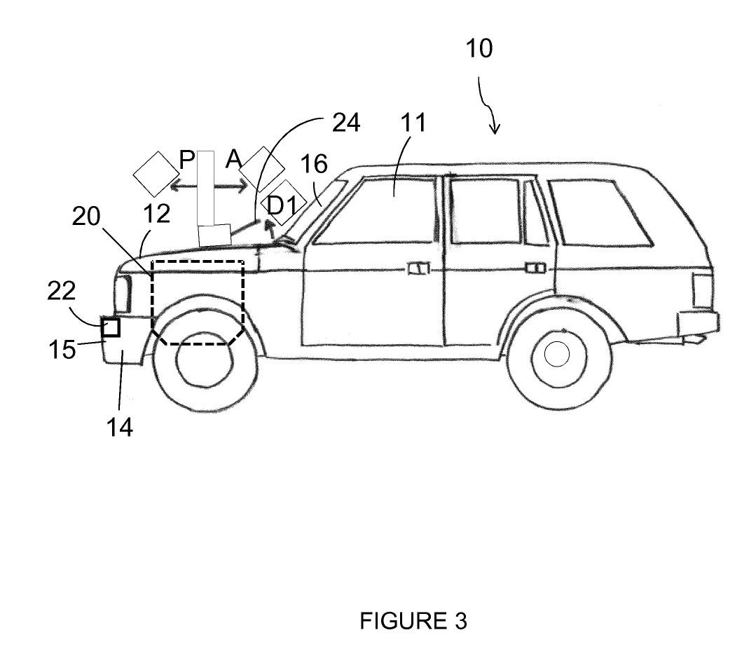

Referring to FIGS. 1 and 3, there is shown a side view (FIG. 2 shows a top view) of a vehicle 10 which comprises a hood or bonnet assembly 12 having an active pedestrian impact section or active section, region, or zone A and a passive pedestrian impact section or passive section, region, or zone P.

The bonnet 12 is disposed in front of a cabin 11 in which the driver may be located. The bonnet 12 defines in part a compartment which may comprise vehicle components such as, but not limited to, an engine 20 and/or suspension components. It is envisaged that in some embodiments, the compartment may be a storage compartment for example for luggage or a spare wheel.

The front of the vehicle 10 has a bumper 14 which comprises a leading edge or surface 15. One or more collision sensors 22 are mounted in or behind the bumper 14. In alternative embodiments collision sensors may be located on or in other areas of the vehicle 10 including but not limited to the body panels. The vehicle 10 also comprises a windshield or windscreen 16. The windscreen 16 is mounted above a cowl 17 (see FIG. 2). Windscreen wipers 18 are provided for clearing precipitation or dirt from the windscreen 16. A wiper motor, linkages and wiper spindles are located beneath or within the cowl 17.

FIG. 2 illustrates a plan view of the vehicle 10. The bonnet 12 comprises at least two zones: a first, passive zone P, and a second, active zone A. The active zone A is located behind, that is to say, rearward of the passive zone adjacent to the cowl 17.

The passive zone P may comprise one or more passive safety devices such as deformable support braces, deformable engine covers, energy absorbing foam and/or a sacrificial space between the bonnet 12 and the engine 20 into which the bonnet 12 may be deformed upon loading by the pedestrian. In some embodiments the passive zone P may comprise an extended energy absorbing nose cone.

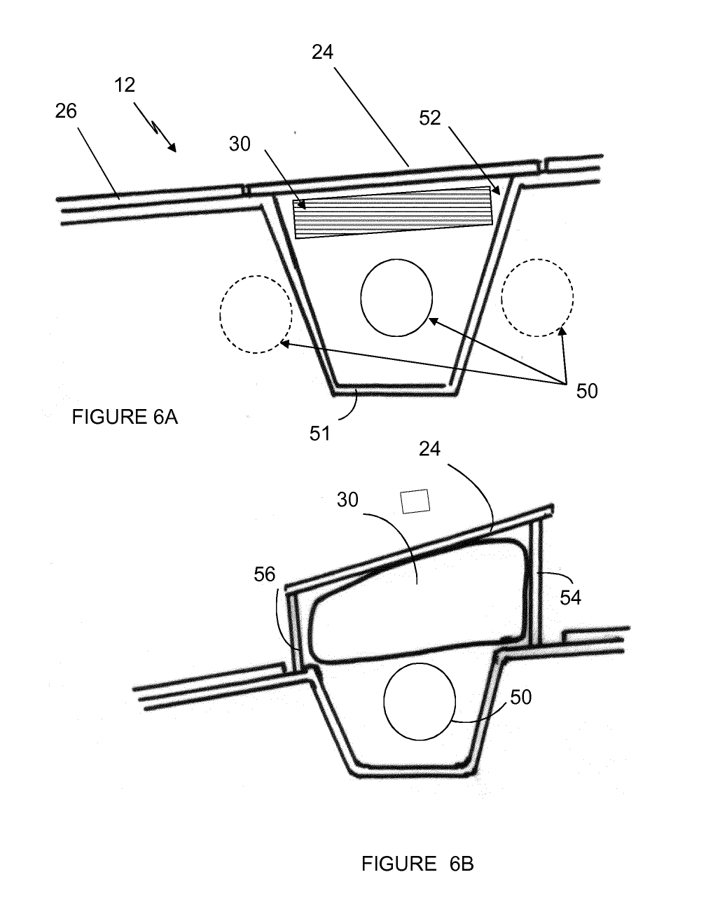

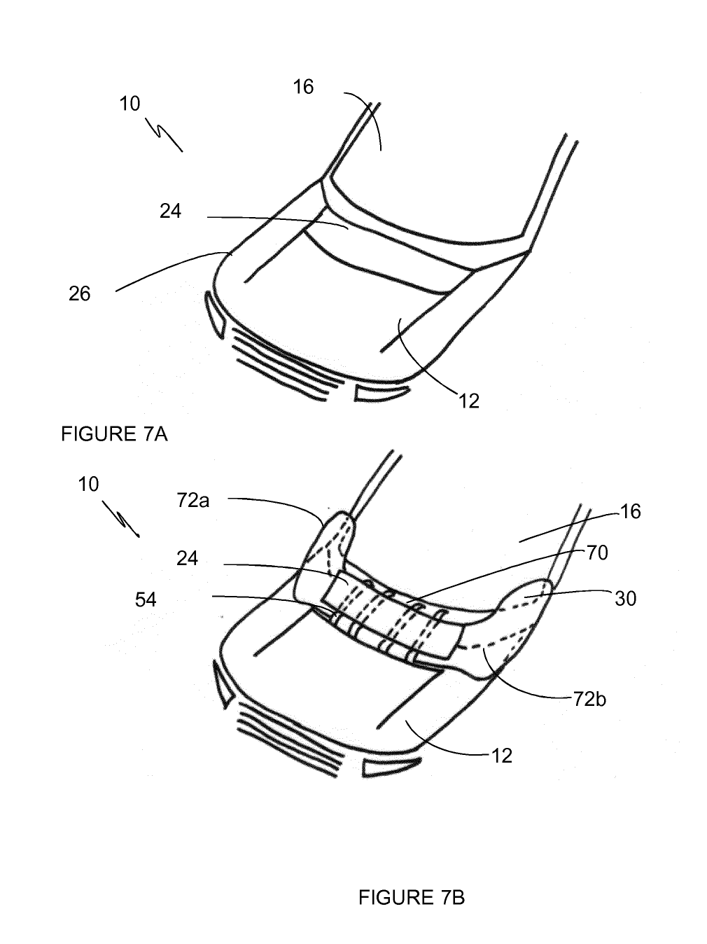

The active zone A comprises a moveable portion covering an actuator. This covering is provided by a moveable panel or flap 24 which can be deployed upon sensing impact with a pedestrian. The flap 24 is raised by an actuator 30, as illustrated in FIG. 6B and 7B. It is envisaged that one or more actuators 30 may be provided. The actuator 30 may comprise an airbag which is pyrotechnically deployed by a control unit which is coupled thereto. On deployment, any load applied to the flap 24 is transferred through the whole area of the flap 24 to the actuator 30 such as an airbag underneath. The flap 24 thus spreads the load, and deformation and/or displacement of the flap 24 towards any vehicle components disposed underneath the flap 24 is managed.

The control unit receives data from one or more sensors on the vehicle 10 including the collision sensors 22. When predetermined criteria are met, the control unit sends a deploy signal to the actuator 30 to raise the flap 24 above the height of the surrounding passive section P of the bonnet 12.

In alternative embodiments the flap 24 may be deployed by alternative actuators such as a pre-tensioned spring mechanism which may or may not be pyrotechnically activated; in some embodiments the actuator may be pneumatically deployed.

It is envisaged that the bonnet 12 will be structured such that the flap 24 may be integrally formed with and is defined within, or struck from the bonnet 12, which is to say it is surrounded by the bonnet 12, and may be stamped out of the bonnet 12. The rear edge of the flap 24 may optionally coincide with the rear edge of the bonnet 12. The flap 24 will be detachably fixed to a support structure disposed thereunder, which is described in more detail below.

FIGS. 3 to 5 illustrate the active bonnet system in a deployed state. The flap 24 has been deployed by activation of the actuator not shown for ease of understanding. The passive zone P is located in front of the active zone A. The active region A of the bonnet 12 has been moved in an upward direction, as indicated by direction arrow D1 (see FIG. 3). Typically the flap 24 may be deployed to a height of 80-100 mm above the bonnet surface in the normal undeployed state.

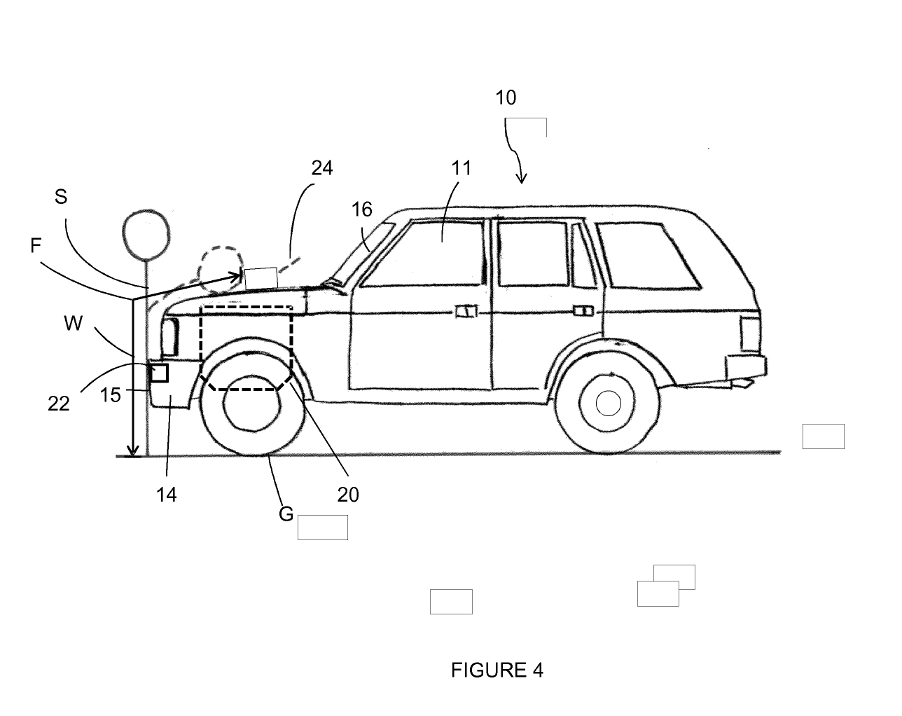

FIG. 4 illustrates schematically the moment of impact between the vehicle 10 and a pedestrian. In the example shown, the stature of the pedestrian is relatively short, as may be representative of an adolescent or short statured adult pedestrian S. The sensors 22 detect the initial impact with the pedestrian S. The control unit determines whether or not to deploy the active region A based upon data received from sensors on the vehicle 10. In some embodiments it is envisaged that the control unit will determine that the vehicle 10 has impacted with a pedestrian S. In such circumstances the active section A may remain undeployed. However, in other embodiments the criteria for deploying the active section A may be met but the pedestrian S may not impact with the active section A. The dashed lines illustrate the condition of the vehicle 10 and pedestrian S at the instant when the upper body of the pedestrian S contacts with the vehicle 10. The upper portion of the pedestrian S contacts with the passive region P of the bonnet 12 and is supported by passive safety measures, such as static energy absorbing structures or material forming at least part of the passive region P.

The distance from the ground G to the point of impact of the head of the pedestrian against the bonnet defines a distance W, hereinafter referred to as the wraparound distance (WAD). The distance W is made up of the distance from the ground to a point of rotation F of the pedestrian about the leading edge of the bonnet, and the distance from that leading edge to the point of contact between the head and the bonnet 12. For any given pedestrian the higher the point F about which the pedestrian wraps or rotates about the vehicle 10, the shorter the time interval, between the initial contact with the leading edge of the vehicle 10 and the contact between the pedestrian's head or upper body with the bonnet 12. The point of rotation F is typically defined by a characteristic of the vehicle 10, such as the height of the leading edge of the bonnet 12. For any given vehicle design, time period between the initial impact with the vehicle and an upper body or head contact with the bonnet 12 is directly proportional to the height of the pedestrian.

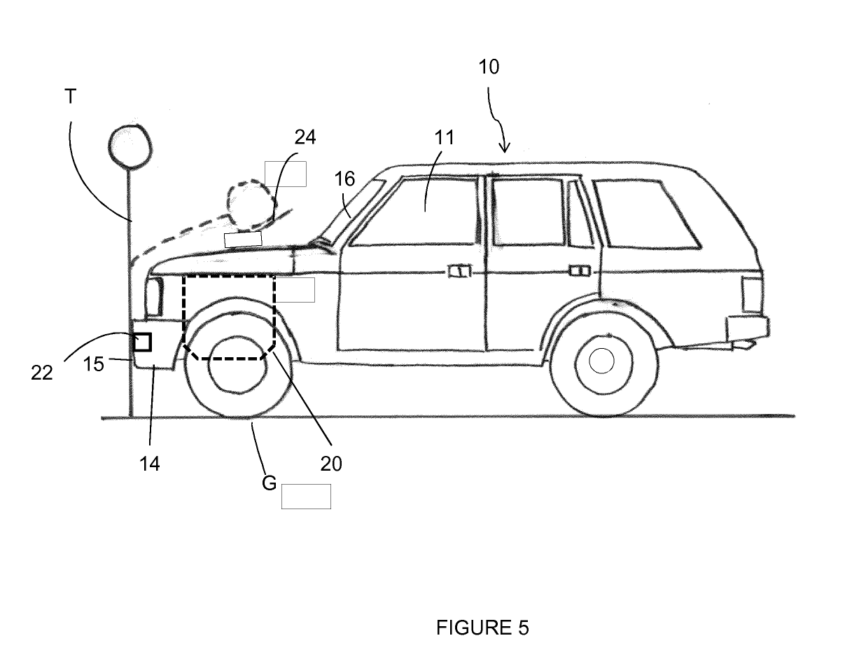

FIG. 5 illustrates schematically the moment of impact between the vehicle 10 and an adult or similarly tall statured pedestrian T. The sensors 22 detect the initial impact and the control unit deploys the active region A of the bonnet 12. The flap 24 is raised to a static or stationary elevated or deployed position prior to any contact between the upper body or head of the pedestrian T with the active region A. The moment in time when the upper body or head of the pedestrian T makes contact with the vehicle 10 is shown in the figures by dashed lines. Thus at least a proportion of the pedestrian T is thus supported by the flap 24 of the active region A. In this way, contact between the pedestrian T and any components beneath the bonnet 12 is avoided by virtue of the increased space below the deployed active region A. This allows for deformation or displacement of the active section A from the deployed position into the space created.

When the actuator is an airbag, deflation of the airbag can be controlled when the pedestrian makes contact with the flap 24, so as to manage and absorb the energy from the impact. This has the further advantage that the rate of deceleration of the can be managed compared with that experienced when making contact with a non-deformable object. In addition, direct contact between the pedestrian T and components of the windscreen wiper 18 such as the wiper spindles, is also avoided.

FIG. 6A illustrates a cross sectional view of a trailing portion of the bonnet 12. The active zone of the bonnet 12 is provided at the trailing edge thereof. A void or cavity 52 is disposed below the flap 24. An airbag 30 is accommodated within the void or cavity 52.

An inflator 50 is provided to inflate the airbag 30, the inflator 50 may be located in a box section 51 of the bonnet 12, or alternatively may be outside the box section 51 (as indicated by phantom lines).

FIG. 6B illustrates the bonnet 12 in a deployed condition. The flap 24 has been moved upwardly by the inflation of the airbag 30, shown in an inflated condition, beneath the flap 24. In this embodiment the airbag 30 has acted as the actuator to deploy the flap 24.

The system comprises the flap 24 and one or more restrictors or tethers 54, 56. The tethers or restrictors 54, 56 limit or constrain the upward travel of the flap 24 and may also restrict or otherwise control at least a portion of the airbag 30 at least in a substantially upward or vertical direction during inflation. The tethers 54, 56 are secured to a non-deploying part of the bonnet 12 such as an edge region of the box section 51 and couple the flap 24 thereto during deployment. The tethers 54, 56 may terminate at securing points (also not shown) on the underside of the flap 24, or may pass through the securing points and terminate at anchorage points (not shown) provided on the bonnet 12.

Restricting upward movement of the flap 24 serves to prevent the airbag 30 obscuring the forward field of view for the driver in the event that the flap 24 is deployed.

FIG. 7A illustrates a perspective view from above of a leading portion of a vehicle 10.

Bonnet 12 comprises a flap 24 forming an active protection zone disposed toward the rear of the bonnet 12.

In this embodiment the flap 24 is substantially flush with the passive section of the bonnet 12. The airbag 30 is disposed beneath the flap 24.

In the deployed state, FIG. 7B, the airbag 30 comprises lateral outer portions 72a, 72b which extend beyond the lateral extent of the flap 24 so as to cover outer portions of the bonnet 12.

Optionally, as illustrated, the airbag 30 extends in a longitudinal direction along outer portions of the bonnet 12 and extends at least partially up the frame surrounding the windscreen 16, such that the airbag 30 is substantially U shaped. Other shapes are envisaged such as but not limited to an H-shape or V-shape. The airbag may also extend at least partially over the cowl. A central region 70 of the airbag 30 is disposed beneath the flap 24. Optionally, the central region 70 of the airbag 30 when fully inflated has a maximum elevation which is lower than the maximum elevation of the flap 24. The outer portions 72a, 72b when fully inflated may have a greater maximum elevation than a central region 70 of the airbag 30 and/or that of the flap 24 when in the deployed position.

Typically the flap 24 and/or airbag 30 may be deployed to a maximum height of 80-100 mm above the bonnet surface in the normal undeployed state.

Typically the airbag 30 will be deployed and stable within a time period of 50-75 ms from the initial impact, or receipt of a deploy signal from the control unit. The airbag 330 may remain inflated at working pressure for a pre-determined period, for example between 250 ms and 1000 ms from the receipt of a deploy signal from the control unit.

The deployment height of the flap 24 or airbag 30 may be controlled by the maximum travel of flap 24 allowed by the tethers 54, 56; the length of the tethers in taut condition determining the deployment height.

In this embodiment the airbag 30 is the actuator which deploys the flap 24.

In some embodiments a second airbag (not shown) may be employed; one airbag may deploy the flap 24 and the other may be deployed from beneath the flap 24 over the vehicle cowl 17, windscreen wipers 18, a lower portion of the windscreen 16 and/or the vehicle structure surrounding the windscreen 16 as may be desired.

In the stowed or non-deployed position the flap 24 is fixed to the box section 51, this may be achieved using clips which may optionally be tapered or conical in shape to facilitate alignment of the flap 24 within the bonnet 12. The airbag 30 and inflator 50 may be provided in a separate package which is fixedly attached to a support member of the bonnet 12. The flap 24 may be provided as part of the separate package and may be coupled thereto by the tethers 54, 56, in some embodiments the flap 24 may be clipped to the package.

The tethers 54, 56 may be formed from a belt or cord, for example the tethers 54, 56 may be constructed from flat webbing formed from polyester, nylon or other suitable material. One or more tethers 54, 56 may be fixed to the leading edge 56 of the flap 24 and one or more separate tethers 54 may be fixed to the trailing edge of the flap 24.

A single tether 54, 56 may be used to simultaneously control the leading and trailing edge of the flap 24. The tethers 54, 56 may be fixed to the flap 24 or may pass through channels or brackets on the lower surface or the flap 24 such that the flap 24 may slide along the tethers 54, 56. Preferably, the tethers 54, 56 are provided with studs or rivets arranged to limit excursion of the tether through the channels or brackets. Such an arrangement may be used to control the extent to which the flap 24 may slide forward or backward along the tethers 54, 56 when supporting the pedestrian in use. Alternatively, the excursion of the flap 24 may be controlled by stitching multiple thicknesses of webbing together along the length of the tethers 54, 56, to form locally thickened regions, arranged to be too thick to pass freely through the channels.

A plurality of clips may fix the flap 24 to the bonnet 12. In some embodiments the plurality of clips may be detached simultaneously to free the flap 24 from the bonnet 12. In alternative embodiments the clips fixing the flap 24 to the bonnet 12 may be configured and arranged such that they can be detached sequentially, the flap may be ‘unzipped’ from one side to the other or from opposing sides to the middle. The tethers 54, 56 and/or airbag 30 may be arranged to facilitate the sequential separation of the clips.

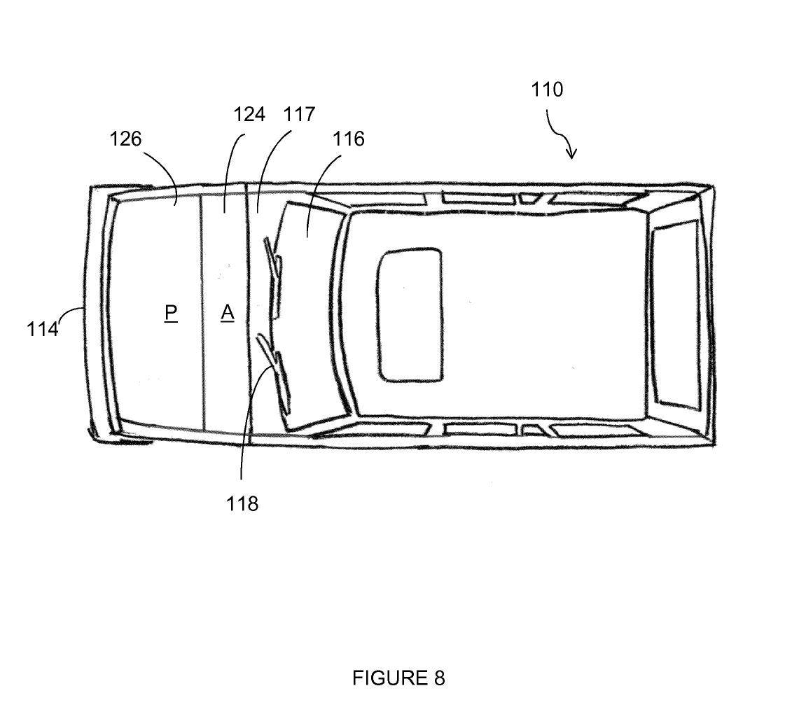

Referring now to FIG. 8, there is shown an alternative embodiment of the present invention. In the this embodiment, like numerals have, where possible, been used to denote like parts, albeit with the addition of the prefix “1” to indicate that these features belong to the alternative embodiment. The alternative embodiment shares many common features with the embodiments of FIGS. 1 to 7 and therefore only the differences from the embodiment illustrated in FIGS. 1 to 7 will be described in any greater detail.

FIG. 8 illustrates a plan view from above of a vehicle 110 according to an alternative embodiment. In this embodiment, the moveable panel or flap 124 which forms part of the active zone of the hood or bonnet 112 extends across the entire width of the bonnet 112.

In yet further embodiments the bonnet 112 may be formed such that the flap 124 is shaped to incorporate an air intake, vent or other trim feature which may be formed separately from the bonnet 112 and is inserted into the bonnet 112. The trim feature may be held in place by one or more frangible fixing devices which may be broken upon activation of the actuator.

In the foregoing embodiments, the control unit may receive data from a variety of sensors 22, 122 or measurement devices on the vehicle, such as but not limited to fibre optic sensors for detecting a collision, vehicle or wheel speed sensors, mechanical contact sensors or switches activated by deformation of the bumper 14, 114 or other vehicle components, or accelerometers for detecting any significant vibrations in the vehicle structure caused by an impact with an external object and/or for detecting the degree of deceleration experienced as a result of such an impact. In some embodiments the flap 24, 124 may be defined in a region of the bonnet disposed adjacent or above an air intake or vent defined within the bonnet.

The tethers may be of a length so that when the flap is fully deployed, a planar surface of the flap is presented for optimal pedestrian support. Further, the tethers may be arranged such that an entire surface of the flap is held in contact with the airbag. The tethers may also be of a length to restrain the flap and the airbag to limit obscuration of the view of the driver. For example, the tethers at the rear of the flap may be longer than those at the front. This enables a face of the flap to be partially forward facing, i.e. the deployed flap is inclined downwardly towards the front of the vehicle.

In some embodiments the passive protection measures provided in the passive protection zone of the bonnet may overlap with the leading edge of the active protection zone.

It will be appreciated that in the foregoing embodiments the flap creates a deployable region of the bonnet which is active in the event of a collision with a pedestrian wherein the deployable region forms a moveable energy absorbing zone, the deployable region being deformable or moveable thereby absorbing at least some of the energy from the contact with the mass of the pedestrian. The deployable region may be deformed or displaced into the space created by deploying the flap into an elevated position above the vehicle component disposed beneath. The control unit is arranged to command deployment of the flap in such a way as to be fully deployed and static before contact with the pedestrian, thus providing a stable supporting structure for mitigating pedestrian injury.

The bonnet therefore comprises a first, passive section disposed at a fixed distance above the vehicle components disposed beneath and is static relative to the vehicle and an active section which is moveable relative to the static passive section, such that in normal use it is disposed at a first distance above the vehicle components, and in the event of a pedestrian impact the active section can be deployed such that it is disposed at a second distance above the vehicle components, the second distance being greater than the first distance.

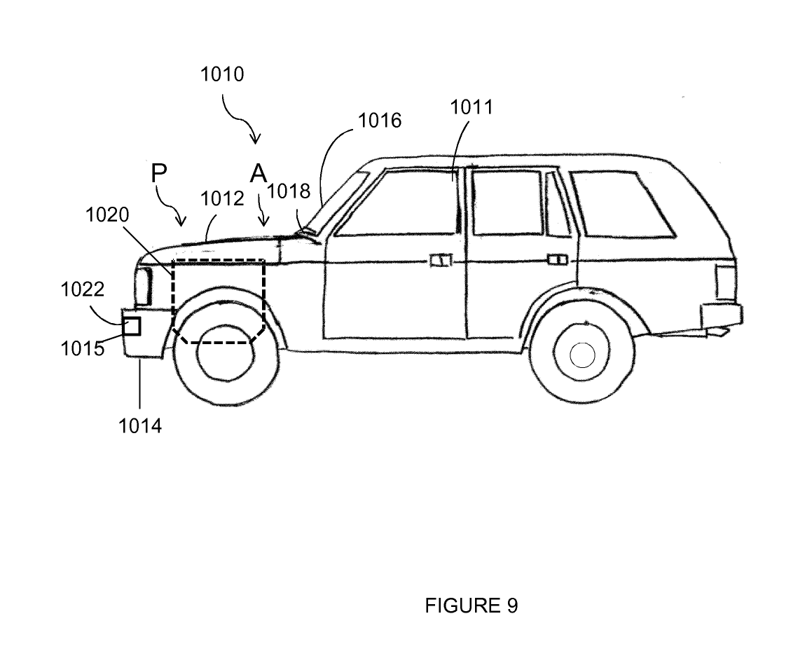

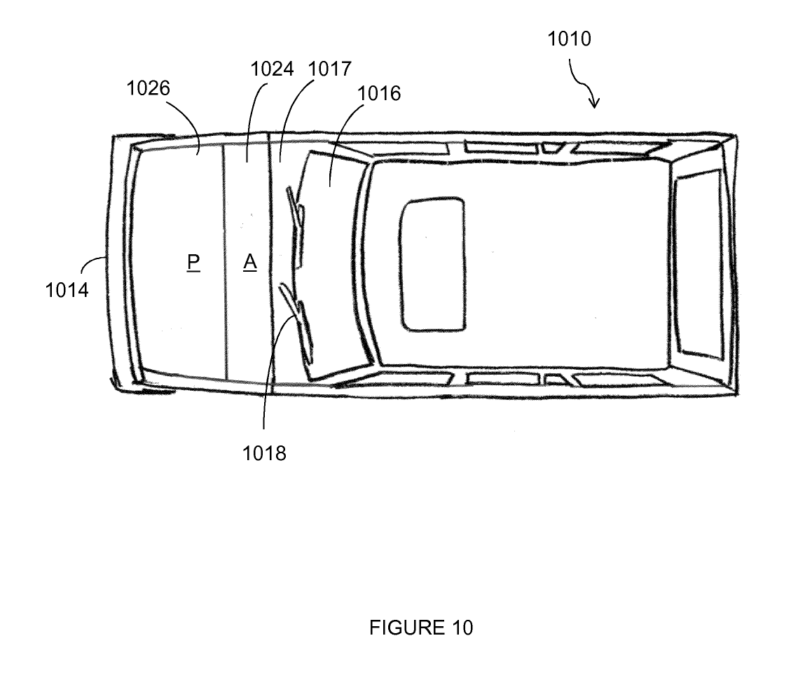

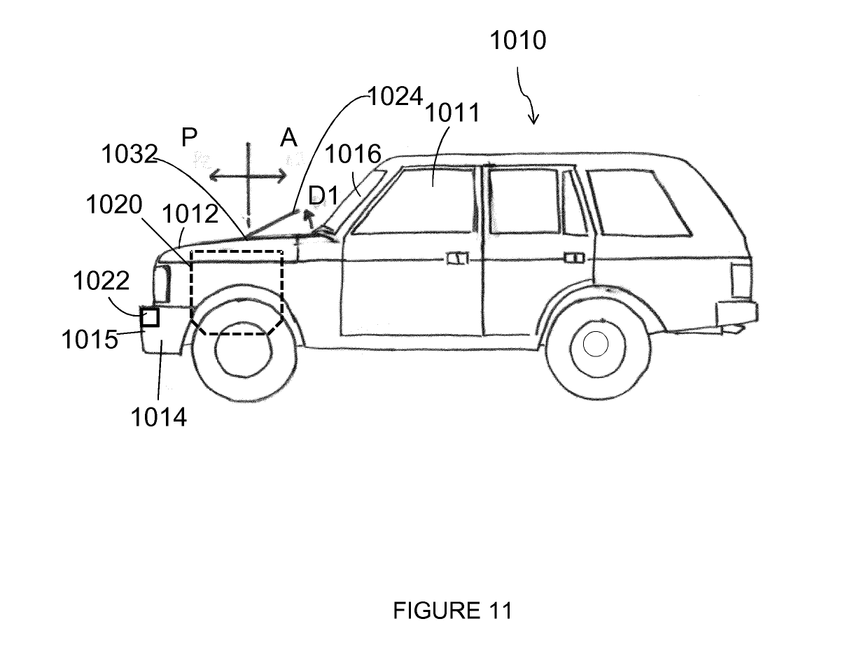

Referring to FIGS. 9 and 11, there is shown a side view (FIG. 10 shows a top view) of a vehicle 1010 which comprises a hood or bonnet assembly 1012 having an active pedestrian impact section or active section, region, or zone A and a passive pedestrian impact section or passive section, region, or zone P.

The bonnet 1012 is disposed in front of a cabin 1011 in which the driver may be located. The bonnet 1012 defines in part a compartment which may comprise vehicle components such as, but not limited to, an engine 1020 and/or suspension components. It is envisaged that in some embodiments, the compartment may be a storage compartment for example for luggage or a spare wheel.

The front of the vehicle 1010 has a bumper 1014 which comprises a leading edge or surface 1015. One or more collision sensors 1022 are mounted in or behind the bumper 1014. In alternative embodiments collision sensors may be located on or in other areas of the vehicle 1010 including but not limited to the body panels. The vehicle 1010 also comprises a windshield or windscreen 1016. The windscreen 1016 is mounted above a cowl 1017 (see FIG. 10). Windscreen wipers 1018 are provided for clearing precipitation or dirt from the windscreen 1016. A wiper motor, linkages and wiper spindles are located beneath or within the cowl 1017.

FIG. 10 illustrates a plan view of the vehicle 1010. The bonnet 1012 comprises at least two sections: a first, passive section P, and a second, active section A. The active section A is located behind, that is to say, rearward of the passive section adjacent to the cowl 1017.

The passive section P may comprise one or more passive safety devices such as deformable support braces, deformable engine covers, energy absorbing foam and a sacrificial space between bonnet 1012 and engine 1020 into which the bonnet 1012 may deform upon impact. In some embodiments the passive section P may comprise an extended energy absorbing nose cone.

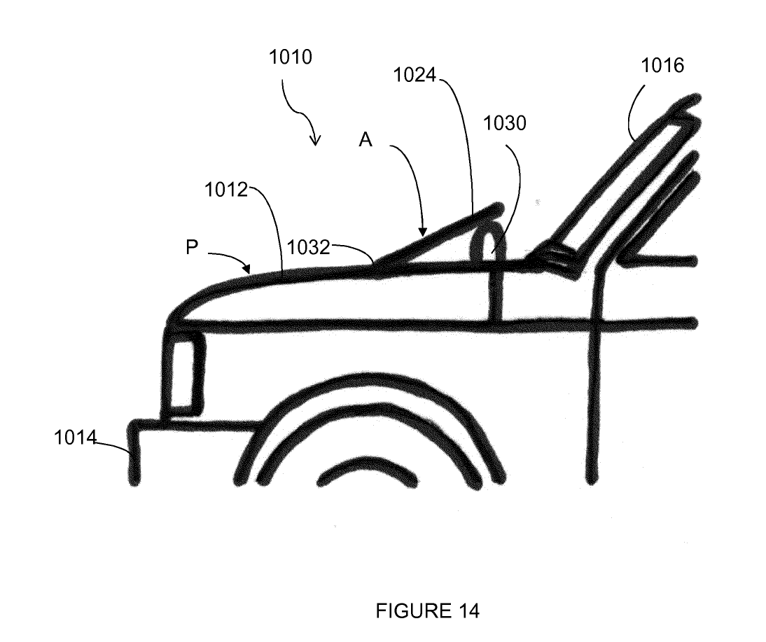

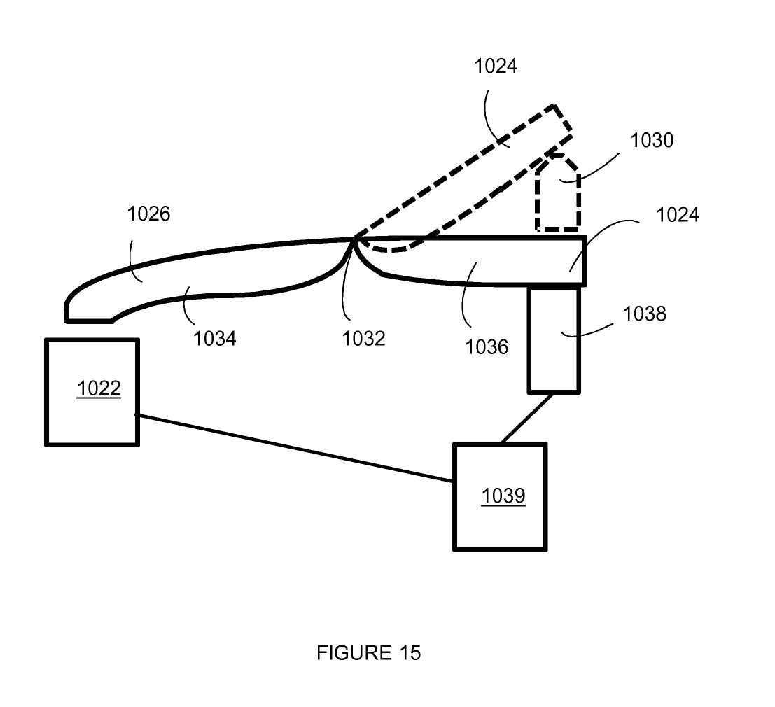

The active section A comprises a moveable portion which is a moveable panel or flap 1024 which can be deployed upon sensing impact with a pedestrian S. The flap 1024 is raised by an actuator 1030, as illustrated in FIG. 14. It is envisaged that one or more actuators 1030 may be provided. The actuator 1030 may comprise an airbag which is pyrotechnically deployed by a control unit 1039 which is coupled thereto, see FIG. 15. On deployment, any load applied to the flap 1024 is transferred through the whole area of the flap 1024 to the actuator 1030 such as an airbag underneath. The flap 1024 thus spreads the load, and deformation and/or displacement of the flap 1024 towards any vehicle components disposed underneath the flap 1024 is managed.

The control unit 1039 receives data from one or more sensors on the vehicle 1010 including the collision sensors 1022. When predetermined criteria are met, the control unit 1039 sends a deploy signal to the actuator 1030 to raise the flap 1024 above the height of the surrounding passive section P of the bonnet 1012.

In alternative embodiments the flap 1024 may be deployed by alternative actuators such as a pre-tensioned spring mechanism which may or may not be pyrotechnically activated; in some embodiments the actuator may be pneumatically deployed.

It is envisaged that the bonnet 1012 will be structured so as to bend or hinge about a predetermined location of the bonnet 1012. FIG. 15 illustrates a schematic representation of a cross-section through the bonnet 1012. The bonnet 1012 has been constructed so as to have a live hinge 1032. When in the undeployed condition, the live hinge 1032 is not visible from an external vantage point above the bonnet 1012. The sheet material of the bonnet 1012 and/or any associated support braces 1034, 1036 may be reduced in thickness to define a localised weak point relative to the rest of the bonnet 1012. Upon activation of the actuator 1030, the flap 1024 hinges about the live hinge 1032. In alternative embodiments the actuator 1030 may only displace an outer skin or surface of the bonnet 1012, the support braces 1034, 1036 may not necessarily be displaced, or a conventional hinge mechanism between the two sections may be used.

FIGS. 11 and 14 illustrate the active bonnet system in a deployed state. The flap 1024 has been deployed by activation of the actuator 1030. The passive section P is located in front of hinge 1032; the active section A is located behind the hinge 1032. The active region A of the bonnet 1012 has been pivotally moved, as indicated by direction arrow D1 (see FIG. 11), about the hinge 1032. Typically the flap 1024 may be deployed to a height of 80-100 mm above the bonnet surface in the normal undeployed state.

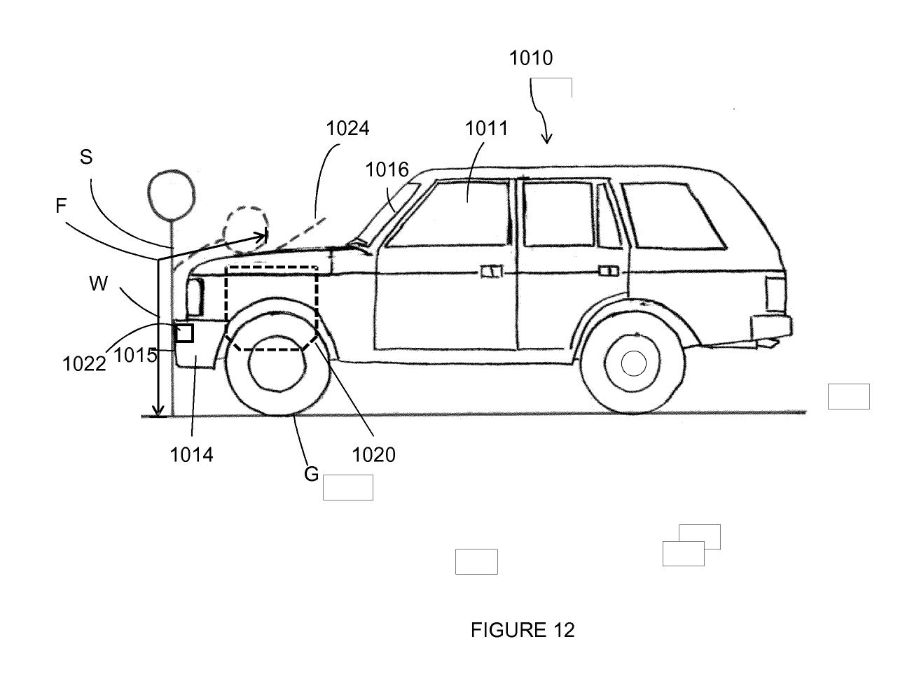

FIG. 12 illustrates schematically the moment of impact between the vehicle 1010 and a pedestrian. In the example shown, the stature of the pedestrian is relatively short, as may be representative of an adolescent or short statured adult pedestrian S. The sensors 1022 detect the initial impact with the pedestrian S. The control unit 1039 determines whether or not to deploy the active region A based upon data received from sensors on the vehicle 1010. In some embodiments it is envisaged that the control unit 1039 will determine that the vehicle 1010 has impacted with a pedestrian. In such circumstances the active region A may remain undeployed. However, in other embodiments, the dashed lines illustrate the condition of the vehicle 1010 and pedestrian S at the instant when the upper body of the pedestrian S contacts the vehicle 1010. The upper portion of the pedestrian S contacts the passive region P of the bonnet 1012 and is supported by passive safety measures, such as static energy absorbing structures or material, forming at least part of the passive region P.

The distance from the ground G to the point of impact of the head of the pedestrian S defines a distance W, hereinafter referred to as the wraparound distance (WAD). The distance W is made up of the distance from the ground to a point of rotation F of the pedestrian about the leading edge of the bonnet, and the distance from that leading edge to the point of contact between the head and the bonnet 1012. For any given pedestrian the higher the point F where the pedestrian wraps or rotates about the vehicle 1010, the shorter the time interval between the initial contact with the leading edge of the vehicle 1010 and the contact between the pedestrian's head or upper body and the bonnet 1012. The point of rotation F is typically defined by a characteristic of the vehicle 1010, such as the height of the leading edge of the bonnet 1012; for any given vehicle design, the time period between the initial impact with the vehicle and an upper body or head contact with the bonnet 1012 is directly proportional to the height of the pedestrian.

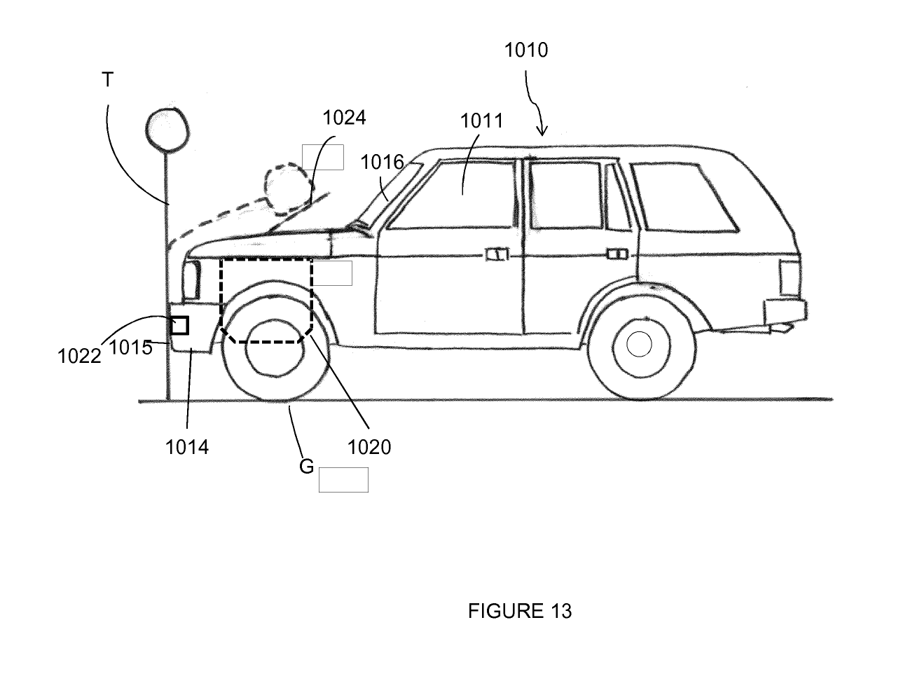

FIG. 13 illustrates schematically the moment of impact between the vehicle 1010 and an adult or similarly tall statured pedestrian T. The sensors 1022 detect the initial impact and the control unit 1039 deploys the active region A of the bonnet 1012. The flap 1024 is raised to a static elevated position prior to any contact between the upper body or head of the pedestrian T with the active region A. The moment in time when the upper body or head of the pedestrian T makes contact with the vehicle 1010 is shown in the figures by dashed lines. Thus at least a proportion of the pedestrian T is thus supported by the flap 1024 of the active region A. In this way, contact between the pedestrian T and any components which are disposed beneath the bonnet 1012 is avoided by virtue of the increased space for deformation below the deployed active region A. In addition, direct contact between the pedestrian T and components of the windshield wiper 1018 such as the wiper spindles, is also avoided.

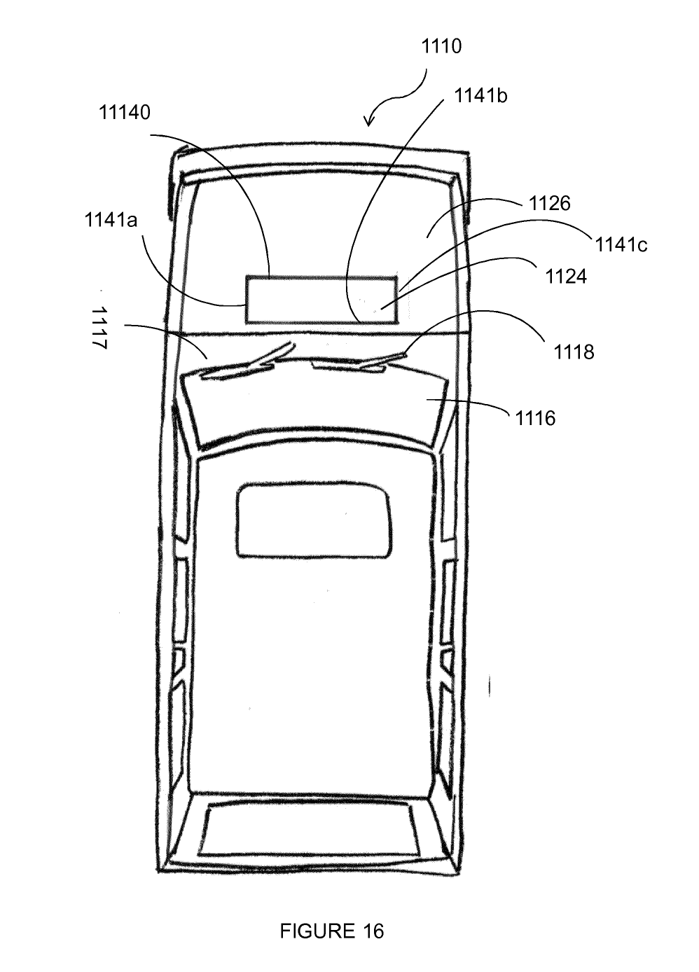

Referring now to FIGS. 16 to 18B, there are shown alternative embodiments of the present invention. In the these embodiments, like numerals have, where possible, been used to denote like parts, albeit with the addition of the prefix “1”, “2”, or “3” to indicate that these features belong to the alternative embodiments. The alternative embodiments share many common features with the embodiments of FIGS. 9 to 15 and therefore only the differences from the embodiment illustrated in FIGS. 9 to 15 will be described in any greater detail.

FIG. 16 illustrates an above, plan view of a vehicle 1110 according to an alternative embodiment. In this embodiment, the door or flap 1124, which forms part of the active section of the hood or bonnet 1112 may be integrally formed with and defined within, or struck from, the bonnet 1112, which is to say it is surrounded by the bonnet 1112, and may be stamped out of the bonnet 1112, whereas in the first embodiment the flap 1024 extends across the entire width of the bonnet 1012. In an alternative embodiment, the flap 1124 may similarly extend across only a portion of the width of the bonnet, but not be integrally formed with the rest of the bonnet.

In yet another embodiment a trailing edge of the flap 1124 may extend to be coincident with a trailing edge of the bonnet 1112.

In this embodiment the flap 1124 is pivotally coupled to the bonnet 1112 along a hinge line 1140. The flap 1124 is further defined by lines of separation 1141a, 1141b, 1141c. These lines of separation are arranged to permit displacement of the flap 1124 relative to the bonnet 1112 upon activation of the actuator 1030.

In alternative embodiments the bonnet 1112 may be formed such that the flap 1124 is separated from the remainder of the bonnet 1112 along the lines of separation 1141a, 1141b, 1141c, for example the bonnet 1112 may be shaped to incorporate an air intake or air vent or other trim feature which may be formed separately from the bonnet 1112 and is inserted into the bonnet or 1112. The trim feature may be held in place by one or more frangible fixing devices which may be broken upon activation of the actuator.

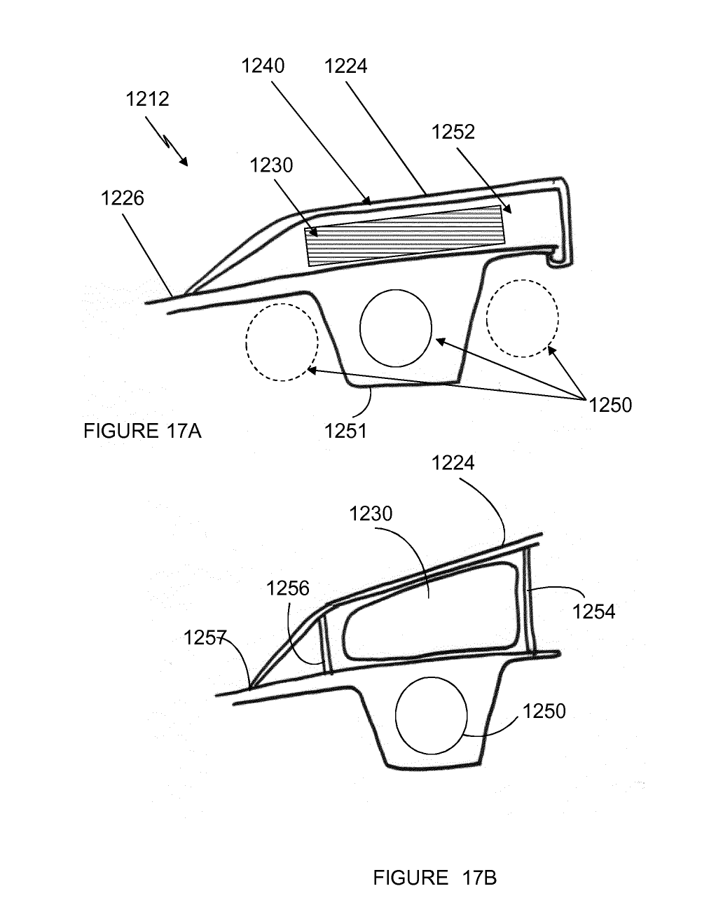

FIG. 17A illustrates a cross sectional view of a trailing portion of a hood or bonnet 1212 according to another embodiment of the invention. In this embodiment the active section of the bonnet 1212 is provided with a bulge, vent or raised section 1240 at the trailing edge, part or all of the raised section 1240 defines a door or flap 1224. A void or cavity 1252 is disposed below the raised section 1240. An airbag 1230 is accommodated within the void or cavity 1252.

An inflator 1250 is provided to inflate the airbag 1230, the inflator 1250 may be located in a box section 1251 of the bonnet 1212, or alternatively may be outside the box (as indicated by phantom lines).

FIG. 17B illustrates the bonnet 1212 in a deployed condition. The flap 1224 has pivotally moved about a hinge line 1257, defined at the leading edge of the raised section 1240. In alternative embodiments the flap 1224 may hinge about a different location. The airbag 1230 is shown in an inflated condition beneath the flap 1224. In this embodiment the airbag 1230 has acted as the actuator to deploy the flap 1224.

The system may optionally be provided with one or more tethers or restrictors 1254, 1256. The tethers or restrictors 1254, 1256 limit the upward travel of the flap 1224 and optionally, may also restrict or otherwise constrain at least a portion of the airbag 1230 at least in a substantially upward or vertical direction during inflation.

Restricting upward movement of the flap 1224 serves to prevent the airbag 1230 obscuring the forward field of view for the driver in the event that the flap 1224 is deployed.

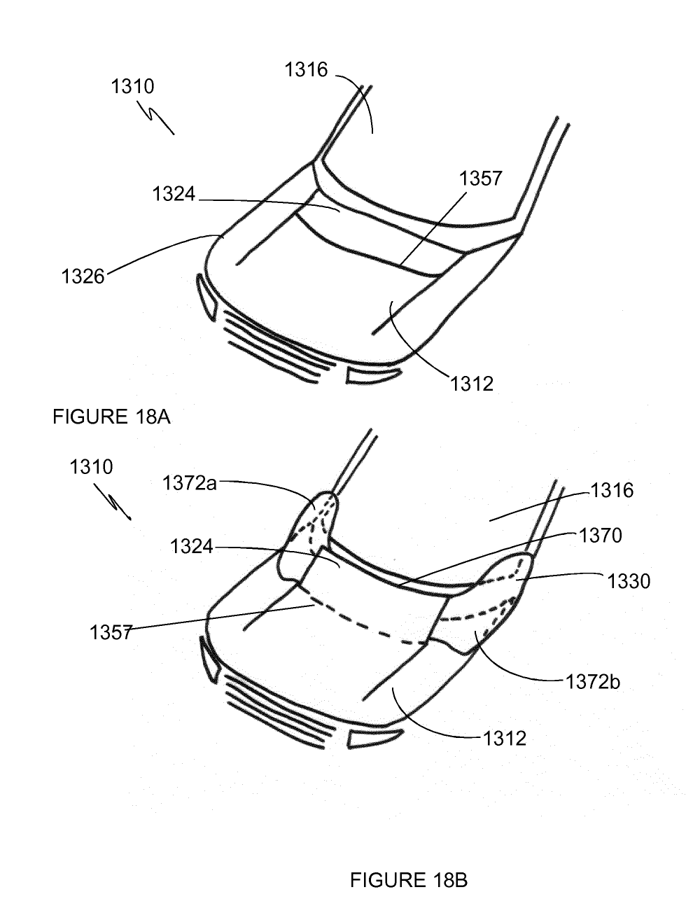

FIG. 18A illustrates a perspective view from above of a leading portion of a vehicle 1310.

Bonnet or hood 1312 comprises a door or flap 1324 forming an active protection section disposed toward the rear of the bonnet 1312.

In this embodiment the flap 1324 is substantially flush with the passive section of the bonnet 1312. The airbag 1330 is disposed beneath the flap 1324.

In the deployed state, FIG. 18B, the airbag 1330 comprises lateral outer portions 1372a, 1372b which extend beyond the lateral extent of the flap 1324 so as to cover outer regions of the bonnet 1312, including the hinge area. Upon inflation of the airbag 1330, the flap 1324 is arranged to rotate upwardly along a live hinge line 1357 towards a deployed position. Optionally, as illustrated, the airbag 1330 extends in a longitudinal direction along outer portions of the bonnet 1312 and extends at least partially up the frame surrounding the windshield 1316, such that the airbag 1330 is substantially U shaped. The airbag also extends at least partially over the cowl. A central region 1370 of the airbag 1330 is disposed beneath the flap 1324.

Optionally, the central region 1370 of the airbag 1330 when fully inflated has a maximum elevation which is lower than the maximum elevation of the flap 1324. The outer portions 1372a, 1372b when fully inflated may have a greater maximum elevation than a central region 1370 of the airbag 1330 and/or that of the flap 1324 when in the deployed position.

In this embodiment the airbag 1330 is the actuator which deploys the flap 1324. Typically the flap 1324 and/or airbag 1330 may be deployed to a maximum height of 80-100 mm above the normal position of the flap 1324 in its undeployed state.

Typically the airbag will be deployed and stable within a time period of 50-75 ms from the initial impact, or receipt of a deploy signal from the control unit. The airbag 1330 may remain inflated at working pressure for a pre-determined period, for example between 250 ms and 1000 ms from the receipt of a deploy signal from the control unit.

In some embodiments a second airbag (not shown) may be deployed from beneath the flap 1024. This airbag may be deployed over the vehicle cowl 1017, windscreen wipers 1018, a lower portion of the windscreen 1016 and/or the vehicle structure surrounding the windshield 1016 as may be desired.

In the foregoing embodiments, the control unit 1039 may receive data from a variety of sensors 1022 or measurement devices on the vehicle, such as but not limited to fibre optic sensors for detecting a collision, vehicle or wheel speed sensors, mechanical contact sensors or switches activated by deformation of the bumper 1014 or other vehicle components, or accelerometers for detecting any significant vibrations in the vehicle structure caused by an impact with an external object and/or for detecting the degree of deceleration experienced as a result of such an impact.

In some embodiments the flap 1024 may be defined in a region of the bonnet disposed adjacent or above an air intake or vent defined within the bonnet.

It can be appreciated that various changes may be made within the scope of the present invention, for example, in the foregoing embodiments the active section A has been described as being hinged to the passive section P but it may be separated therefrom and pivotally coupled to alternative vehicle components. It is envisaged that in some embodiments the bonnet 1012 may bend or deform across a region to define a radius rather than fold about a hinge line.

Furthermore, in embodiments which include an airbag, the flap need not be hingedly attached to the bonnet assembly or vehicle when deployed, instead, the flap may be attached to the vehicle via tethers. The tethers may be of a length so that when the flap is fully deployed, a planar surface of the flap is presented for optimal pedestrian support. Further, the tethers may be arranged such that an entire surface of the flap is held in contact with the airbag. The tethers may also be of a length to restrain the flap and the airbag to limit obscuration of the view of the driver. For example, the tethers at the rear of the flap may be longer than those at the front. This enables a face of the flap to be partially forward facing, i.e. the deployed flap is inclined downwardly towards the front of the vehicle.

In some embodiments the passive protection measures provided in the passive protection section of the bonnet or hood may overlap with the leading edge of the active protection section.

It will be appreciated that in the foregoing embodiments the flap creates a deployable region of the bonnet which is active in the event of a collision with a pedestrian wherein the deployable region forms a moveable energy absorbing section, the deployable region being deformable thereby absorbing at least some of the energy from the contact with the mass of the pedestrian.

The deployable region may be deformed or displaced into the space created by deploying the flap into an elevated position above the vehicle component disposed beneath. The control unit 1039 is arranged to command deployment of the flap in such a way as to be fully deployed and static before contact with the pedestrian, thus providing a stable supporting structure for mitigating pedestrian injury.

The bonnet therefore comprises a first, passive, section disposed at a fixed distance above the vehicle components disposed beneath and is static and an active section which is moveable such that in normal use it is disposed at a first distance above the vehicle components, in the event of a collision the active section can be deployed such that it is disposed at a second distance greater than the first distance.

It will be appreciated that the foregoing invention may be employed in a vehicle of any shape or profile; the height of the leading edge of the bonnet relative to the height of the pedestrian involved in a collision event may be one of a number of factors that determine whether the pedestrian will impact with the active zone and/or passive zone. This relative height relationship may be one of a number of predetermined criteria used to determine if the active bonnet section should be deployed.

Features described with respect to one embodiment of the invention may be employed with features of other embodiments either in addition or alternative to features of said other embodiments.

It will be recognised that as used herein, directional references such as “top”, “bottom”, “front”, “back”, “end”, “side”, “inner”, “outer”, “upper” and “lower” do not limit the respective features to such orientation, but merely serve to distinguish these features from one another.

The terms bonnet and hood are used interchangeably throughout and are considered to have equivalent meaning.

In the foregoing, the term “pedestrian” has been used to describe a collision between a person and a vehicle. It will be understood that the invention will be of benefit in collisions involving cyclists, motorcyclists and any other mounted road user.

1. A vehicle bonnet assembly for managing the energy from an impact with a pedestrian, the assembly comprising a passive pedestrian impact protection section and an active pedestrian impact protection section wherein both the passive and active pedestrian impact protection sections are provided on an upper surface of the bonnet assembly, the active pedestrian impact protection section being detachable from the passive pedestrian impact protection section, wherein the active pedestrian impact protection section is arranged, in the event of an impact, to detach from and move relative to the passive pedestrian impact protection section.

2. The assembly according to claim 1 wherein the active section is moveable from a non-deployed position to a deployed position, whereby when the active section is in the deployed position it provides an increased space for displacement or deformation between the active section and vehicle components therebeneath than when the active section is in the non-deployed position.

3. The assembly according to claim 2 wherein on deployment of the active pedestrian impact section, movement thereof is constrained.

4. The assembly according to claim 1 wherein the bonnet assembly is arranged such that when the active pedestrian impact section is deployed, the bonnet assembly does not obscure a driver's view from the vehicle.

5. The assembly according to claim 1 wherein the active section is located rearwards of the passive section.

6. The assembly according to claim 1 wherein the bonnet assembly comprises an actuator for elevating a moveable portion of the active section of the bonnet assembly.

7. The assembly according to claim 6 wherein the actuator is an airbag.

8. The assembly according to claim 6 wherein the actuator is one of pyrotechnically activated and pneumatically activated.

9. The assembly according to claim 1 comprising one or more tethers to limit or restrict movement of the moveable portion.

10. (canceled)

11. (canceled)

12. The assembly according to claim 7 wherein the airbag, when fully inflated, extends beyond a lateral extent of the moveable portion.

13. (canceled)

14. The assembly according to claim 7 wherein the moveable portion is disposed over the airbag and substantially covers at least a central portion of the airbag when in the deployed position.

15. The assembly according to claim 7 wherein one or more lateral outer portions of the airbag have a greater maximum elevation than a central region of the airbag and/or than the moveable portion in the deployed position.

16. The assembly according to claim 1 wherein the bonnet assembly is coupled to a control unit for receiving data input from one or more sensors and/or other measurement devices disposed on the vehicle and is operable to determine, based on predefined criteria whether to deploy the active pedestrian impact protection section.

17. The assembly according to claim 1 wherein the passive pedestrian impact protection section comprises a passive, static or non-deploying, energy absorbing region, the active pedestrian impact protection section comprises a moveable portion moveable between a first, stowed, position and a second, deployed, position, wherein deployment of the moveable portion increases the distance between the moveable portion and vehicle components disposed beneath the active section.

18. The assembly according to claim 1 wherein the moveable portion extends across the entire bonnet of the vehicle.

19. The assembly according to claim 1 in which the active pedestrian impact protection section is disposed towards the rear of the bonnet or hood.

20. The assembly according to claim 7 wherein, in the deployed position, the moveable portion of the bonnet assembly floats or is suspended upon the airbag, and wherein the airbag supports the moveable portion.

21. The assembly according to claim 7 wherein the moveable portion forms an energy absorbing region which is moveable and/or deformable for absorbing energy in a collision, the moveable portion being moveable and/or deformable into a space created by deployment of the moveable portion.

22. A vehicle comprising the bonnet assembly of claim 1.

23. A method of deploying an active region of a vehicle bonnet assembly, the method comprising sensing impact with an object, determining that said object may be a pedestrian, activating an actuator to deploy a section of a vehicle bonnet to an elevated position.

24. (canceled)

25. (canceled)
